(19) United States
(12) Patent Application Publication
(10) Pub. No.: US 2006/0277596 A1
(43) Pub. Date: Dec. 7, 2006

(54) Method and system for multi-instance session support in a load-balanced environment

(76) Inventors: Peter S. Calvert, Felton, CA (US); Brian Eaton, Alexandria, VA (US); Benjamin B. Harmon, Santa Cruz, CA (US); Eric J. Wood, Santa Cruz, CA (US)

Correspondence Address: IBM CORPORATION;INTELLECTUAL PROPERTY LAW, 11400 BURNET ROAD, AUSTIN, TX, 78758, US

(21) Appl. No.: 11/146,969

(22) Filed: Jun. 6, 2005

(51) Int. Cl. H04L 9/32

(52) U.S. Cl. 726/3

(57) ABSTRACT

A method is presented for managing session identifiers amongst a set of servers. The servers receive resource requests from clients, and the servers maintain sessions having session state information wherein each session is associated with a session identifier. When a server sends a response to a client, the response is accompanied by a first cookie and a second cookie, wherein the first cookie contains a copy of the session identifier and the second cookie contains a copy of the session identifier that has been cryptographically protected using a cryptographic key, wherein each server in the set of servers possesses a copy of the cryptographic key. If a server does not recognize the session identifier in the first cookie, the server decrypts the second cookie, and if the session identifier from the cookies are identical, the server will reuse the session identifier rather than generating a new session identifier.

### BACKGROUND OF THE INVENTION

1. Field of the Invention

The present invention relates to an improved data processing system and, in particular, to a method and apparatus for multicomputer data transferring. Still more particularly, the present invention provides a method and apparatus for computer-to-computer session establishing and session parameter setting.

2. Description of Related Art

In a web application environment, enterprises often use support servers to provide authorization, authentication, and session management services as a front-end to web application servers. When the data processing environment needs to be high-performance and/or fault-tolerant, a common deployment scenario utilizes load balancers to distribute the load and/or to dynamically compensate if a server fails. In this scenario, not only do the web applications need to be redundant, but the support servers must be redundant as well.

A problem arises when attempting to maintain a user's session state across redundant servers after a failover event or some other event or determination that causes a user session to be moved between servers. The management of a user session requires unique session state information, and a mechanism is required either to replicate or to regenerate session state information in order to continue supporting operations on behalf of the user. In some environments, operations to support redundancy are replicative: operations for a user can fail over or can be moved to a redundant server that obtains a copy or already has a shadow copy of the user's session state information in some manner. Failover events or other events in these types of environments should result in fairly continuous user service.

In other environments, operations to support redundancy are regenerative: operations for a user can fail over or can be moved to a redundant server that automatically authenticates the user and establishes a new session for that user on the redundant server, herein also called a server replica. Failover events or other events in these types of environments cause new sessions to be created at each new server replica, thereby causing problems in the continuity of user service. In particular, user sessions are uniquely identified; a user is typically linked to the user's session with a unique session identifier, i.e. session ID. Failover events or other events cause new session identifiers to be created at each new server replica, and the session identifiers are not shared nor recognized by other server replicas.

Generation of user session information for a given user may occur at multiple servers within a single data processing environment for reasons other than a failover event. For example, some data processing systems employ a so-called nonsticky load-balanced environment. A nonsticky load balancer maintains no state information about user sessions and can direct requests from clients for user operations to any application server as it chooses. Hence, a series of requests from a particular user do not necessarily stick to the same server, i.e. are not necessarily handled by the same server across a set of user requests. New sessions are created at each server whenever a user request is directed to a new server, even if a session was previously established at that server for a previous user request. Although there may be some server-side performance penalties that are caused by the nonsticky behavior, other server-side benefits may be achieved. However, this type of server behavior may create a performance bottleneck for the user, particularly if the user is required to respond to multiple authentication operations during the user's session.

Therefore, it would be advantageous to have a method and a system to provide robust session management on servers within a load-balanced computing environment.

### SUMMARY OF THE INVENTION

A method is presented for managing session identifiers amongst a set of servers. The servers receive resource requests from clients, and the servers maintain sessions having session state information wherein each session is associated with a session identifier. When a server sends a response to a client, the response is accompanied by a first cookie and a second cookie, wherein the first cookie contains a copy of the session identifier and the second cookie contains a copy of the session identifier that has been cryptographically protected using a cryptographic key, wherein each server in the set of servers possesses a copy of the cryptographic key. If a server does not recognize the session identifier in the first cookie, the server decrypts the second cookie, and if the session identifier from the cookies are identical, the server will reuse the session identifier rather than generating a new session identifier.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical network of data processing systems, each of which may implement the present invention;

FIG. 1B depicts a typical computer architecture that may be used within a data processing system in which the present invention may be implemented;

FIG. 1C depicts a dataflow diagram that illustrates a typical authentication process that may be used when a client attempts to access a protected resource at a server;

FIG. 2A depicts a block diagram that shows a typical enterprise data processing system;

FIG. 2B depicts a block diagram that shows a typical enterprise data processing system that includes a load-balancing server with multiple reverse proxy servers;

FIG. 2C depicts a block diagram that shows a data processing system that includes a load-balancing server with multiple reverse proxy servers that contain functionality for creating and managing session support cookies in accordance with an embodiment of the present invention;

FIG. 2D depicts a block diagram that shows an exchange of a session cookie and a session support cookie between a client and a reverse proxy server in accordance with an embodiment of the present invention;

FIGS. 3A-3B depict a pair of flowcharts that show a process for determining when a reverse proxy server replica should generate new session identifier for a received resource request in accordance with an embodiment of the present invention; and

FIGS. 4A-4H depict a set of block diagrams that show a set of reverse proxy server replicas with respect to partially representative session contexts across a period of time in which requests from a user/client are processed in accordance with an embodiment of the present invention.

### DETAILED DESCRIPTION OF THE INVENTION

In general, the devices that may comprise or relate to the present invention include a wide variety of data processing technology. Therefore, as background, a typical organization of hardware and software components within a distributed data processing system is described prior to describing the present invention in more detail.

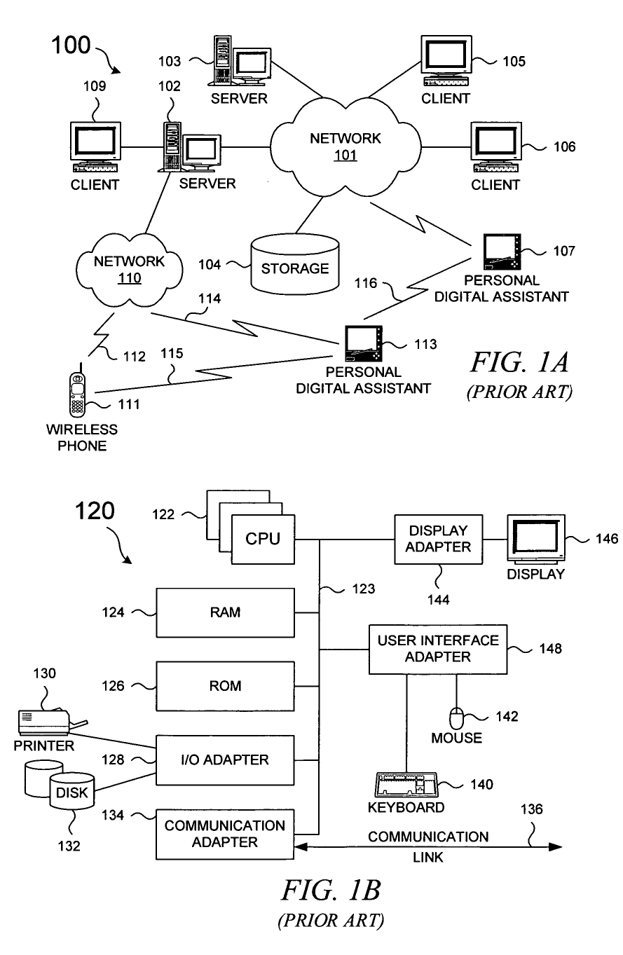

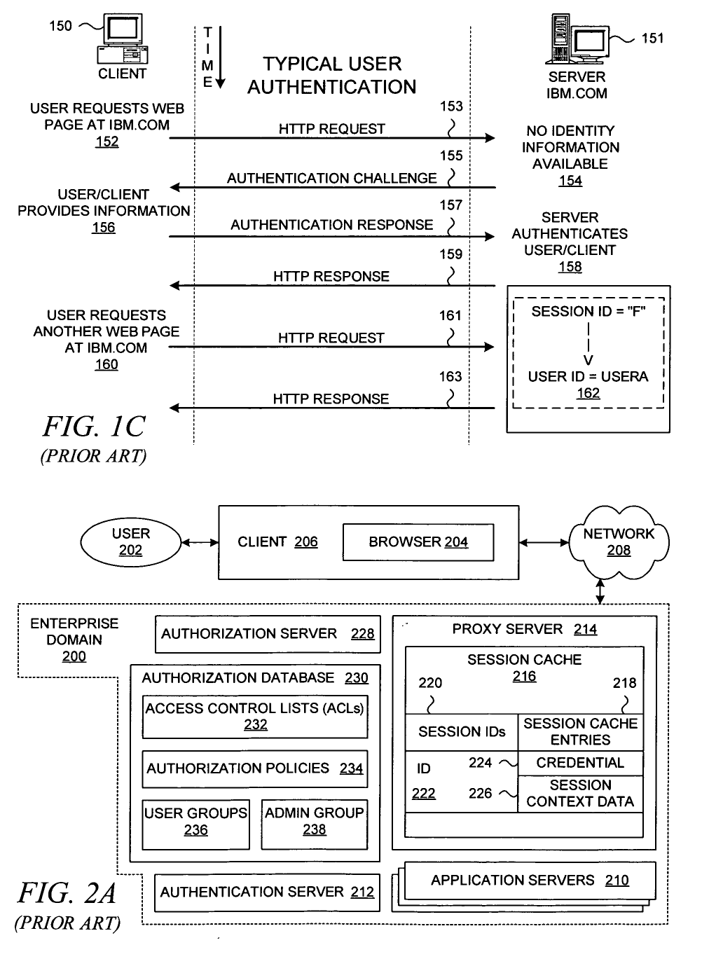

With reference now to the figures, FIG. 1A depicts a typical network of data processing systems, each of which may implement a portion of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown.

In the depicted example, distributed data processing system 100 may include the Internet with network 101 representing a worldwide collection of networks and gateways that use various protocols to communicate with one another, such as Lightweight Directory Access Protocol (LDAP), Transport Control Protocol/Internet Protocol (TCP/IP), File Transfer Protocol (FTP), Hypertext Transport Protocol (HTTP), Wireless Application Protocol (WAP), etc. Of course, distributed data processing system 100 may also include a number of different types of networks, such as, for example, an intranet, a local area network (LAN), or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as an audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Unix® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above with respect to FIG. 1A and FIG. 1B. More specifically, though, the present invention is directed to an improved distributed data processing environment. Prior to describing the present invention in more detail, some aspects of typical distributed data processing environments are described.

The descriptions of the figures herein may involve certain actions by either a client device or a user of the client device. One of ordinary skill in the art would understand that responses and/or requests to/from the client are sometimes initiated by a user and at other times are initiated automatically by a client, often on behalf of a user of the client. Hence, when a client or a user of a client is mentioned in the description of the figures, it should be understood that the terms “client” and “user” can be used interchangeably without significantly affecting the meaning of the described processes.

Certain computational tasks may be described hereinbelow as being performed by functional units. A functional unit may be represented by a routine, a subroutine, a process, a subprocess, a procedure, a function, a method, an object-oriented object, a software module, an applet, a plug-in, an ActiveX™ control, a script, or some other component of firmware or software for performing a computational task.

The descriptions of the figures herein may involve an exchange of information between various components, and the exchange of information may be described as being implemented via an exchange of messages, e.g., a request message followed by a response message. It should be noted that an exchange of information between computational components, which may include a synchronous or asynchronous request/response exchange, may be implemented equivalently via a variety of data exchange mechanisms, such as messages, method calls, remote procedure calls, event signaling, or other mechanism.

With reference now to FIG. 1C, a data flow diagram illustrates a typical authentication process that may be used when a client attempts to access a protected resource at a server. As illustrated, the user at a client workstation 150 seeks access over a computer network to a protected resource on a server 151 through the user's web browser executing on the client workstation. A protected resource is a resource (an application, an object, a document, a page, a file, executable code, or other computational resource, communication-type resource, etc.) for which access is controlled or restricted. A protected resource may be identified by a Uniform Resource Locator (URL), or more generally, a Uniform Resource Identifier (URI), that can only be accessed by an authenticated and authorized user. The computer network may be the Internet, an intranet, or other network, as shown in FIG. 1A or FIG. 1B, and the server may be a web application server (WAS), a server application, a servlet process, or the like.

The process is initiated when the user requests a server-side protected resource, such as a web page within the domain “ibm.com” (step 152). The terms “server-side” and “client-side” refer to actions or entities at a server or a client, respectively, within a networked environment. The web browser (or associated application or applet) generates an HTTP request that is sent to the web server that is hosting the domain “ibm.com” (step 153). The terms “request” and “response” should be understood to comprise data formatting that is appropriate for the transfer of information that is involved in a particular operation, such as messages, communication protocol information, or other associated information.

The server determines that it does not have an active session for the client (step 154), so the server requires the user to perform an authentication process by sending the client some type of authentication challenge (step 155). The authentication challenge may be in various formats, such as an HTML form. The user then provides the requested or required information (step 156), such as a user identifier and an associated password, or the client may automatically return certain information, such as a digital certificate.

The authentication response information is sent to the server (step 157), at which point the server authenticates the user or client (step 158), e.g., by retrieving previously submitted registration information and matching the presented authentication information with the user's stored information. Assuming the authentication is successful, an active session is established for the authenticated user or client.

The server then retrieves the requested web page and sends an HTTP response message to the client (step 159). At that point, the user may request another page within “ibm.com” (step 160) within the browser by clicking a hypertext link, and the browser sends another HTTP request message to the server (step 161). At that point, the server recognizes that the user has an active session based on session state information that is maintained by the server (step 162). For example, the server recognizes the appropriate session state information for the requesting user because the user's client returns a session ID within the HTTP Request message. Based on the cached user session information, the server determines that the user has already been authenticated, e.g., by the availability of a copy of the user's credentials; the server can then determine that certain operations, such as an authentication operation, is not required to be performed prior to fulfilling the user's request. The server sends the requested web page back to the client in another HTTP response message (step 163), thereby fulfilling the user's original request for the protected resource.

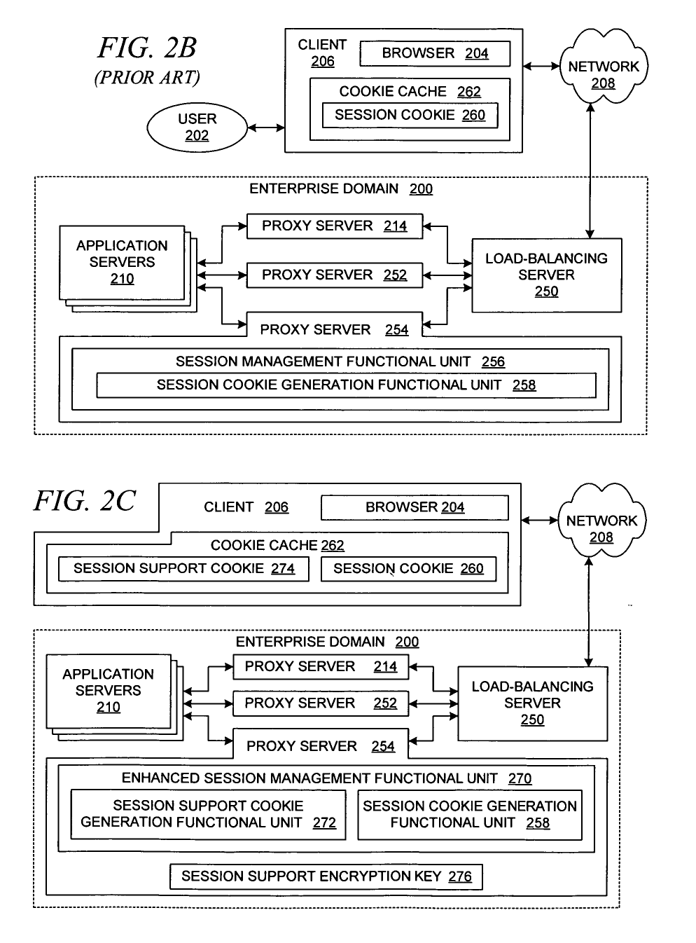

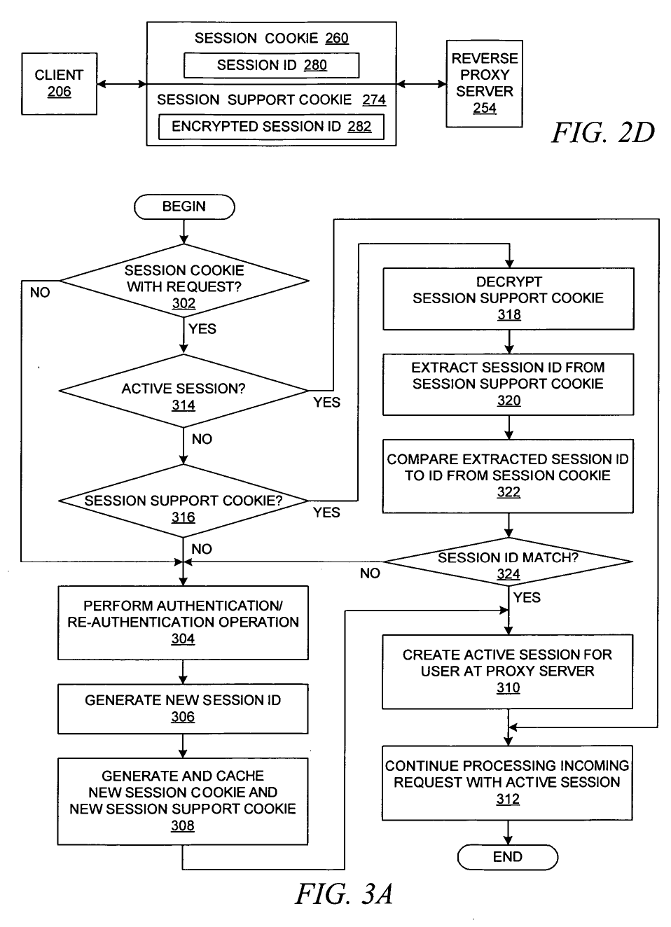

With reference now to FIG. 2A, a block diagram depicts a typical enterprise data processing system. Whereas FIG. 1C depicts a typical authentication process that may be used when a client attempts to access a protected resource at a server, in contrast, FIG. 2A shows some of the server-side entities that may be used to support the authentication process that is shown in FIG. 1C and to support subsequent client requests.

As in a typical corporate computing environment or an Internet-based computing environment, enterprise domain 200 hosts controlled resources that user 202 can access, e.g., by using browser application 204 on client 206 through network 208; the computer network may be the Internet, an intranet, or other network, as shown in FIG. 1A or FIG. 1B. A protected or controlled resource is a resource (an application, an object, a document, a page, a file, executable code, or other computational resource, communication-type resource, etc.) that is only accessed or retrieved if the requesting client or requesting user is authenticated and authorized; in some cases, an authenticated user is, by default, an authorized user.

Enterprise domain 200 supports multiple servers. Application servers 210 support controlled and/or uncontrolled resources through web-based applications or other types of back-end applications, including legacy applications. Reverse proxy server 214, or more simply, proxy server 214, performs a wide range of functions for enterprise domain 200, e.g., caching web pages in order to mirror the content from an application server or filtering the incoming and outgoing datastreams in order to perform various processing tasks on incoming requests and outgoing responses; each check may be performed in accordance with goals and conditions that are specified within various enterprise policies.

The above-noted entities within enterprise domain 200 represent typical entities within many computing environments. As was shown with respect to FIG. 1C, web-based applications typically utilize various means to prompt users to enter authentication information, often as a username/password combination within an HTML form. In the example that is shown in FIG. 2A, user 202 may be required to be authenticated before client 206 may have access to resources, after which a session is established for client 206 in a manner similar to that described above in FIG. 1C. In an alternative embodiment, authentication and authorization operations are not performed prior to providing a user with access to resources on domain 200; a user session is created without an accompanying authentication operation.

Authentication server 212 may support various authentication mechanisms, such as username/password, X.509 certificates, or secure tokens; multiple authentication servers could be dedicated to specialized authentication methods.

After receiving an incoming request from client 206, one of the processing tasks of proxy server 214 may be to determine whether client 206 has already established a session. Proxy server 214 maintains session cache 216; for each session that is activated, proxy server 214 associates a session identifier with any information that is required to maintain the state of the session. In the example shown in FIG. 2A, session cache 216 is organized as a simple two-dimensional table containing session cache entries 218 that are searchable by session identifiers 220. For example, session ID 222 is associated with a session cache entry that contains user credential 224 and/or other session context data 226, such as flags for indicating various session state information; user credential 224 may be retrieved or obtained from an authentication server.

If client 206 has not already established a session, e.g., which may be determined by a failure to recognize or verify a session ID from client 206 and/or which would be indicated by a lack of a session cache entry for client 206, an authentication service on authentication server 212 can be invoked in order to authenticate user 202. If user 202 is successfully authenticated, then a session is activated for client 206, and a session cache entry is created. The authentication service returns a credential to be used in conjunction with any subsequent processing that is performed on behalf of client 206 within enterprise domain 200; the credential is stored in the session cache entry that is associated with client 206.

If client 206 has already established a session, then additional authorization checks may be performed by proxy server 214 on an incoming request prior to granting access to a controlled resource. Before initiating an authorization operation, proxy server 214 locates the session cache entry that is associated with client 206, obtains the credential from the session cache entry, i.e. the credential that was previously associated with client 206 when user 202 was authenticated, and passes the credential and any other appropriate information to authorization server 228.

Proxy server 214 is able to locate the appropriate credential for the incoming request because of a previous series of actions. Within a typical web server environment, session identifiers for user sessions can be echoed from a user's browser application through a variety of mechanisms, e.g., URL rewriting and HTTP cookies. For session identifier management using URL rewriting, when a previous web page was returned to client 206, the URLs within the web page, e.g., those that were associated with hyperlinks to controlled resources, would have been rewritten to append the appropriate session identifier to each hyperlink. When user 202 selected a hyperlink within that web page, browser 204 generated a request to enterprise domain 200 for the web page or other resource that is identified by the URL that is associated with the selected hyperlink. Proxy server 214 parses the URL in the incoming request to retrieve the associated session identifier. For session identifier management using HTTP cookies, an HTTP Response message contains a special “SET-COOKIE” header that has at least one name-value pair, wherein the value of the cookie comprises a session identifier in some manner. When the user's browser application recognizes the “SET-COOKIE” header in the HTTP Response message, the browser sets a cookie in its cookie cache, wherein the cookie is associatively stored with the domain name of the sending domain. When the browser subsequently sends an HTTP Request message to that domain, the browser includes the appropriate cookie in the HTTP Request message. When the cookie contains a session ID, then the session ID is returned to the domain, which may then employ the session ID to recognize the appropriate session state information to be associated with the incoming request. In this manner, a web application server returns a cookie with the session ID with each response to the user's client, and the user's client echoes any appropriate cookie or cookies when sending a subsequent request to a web application server.

Authorization server 228 may employ authorization database 230, which contains information such as access control lists 232, authorization policies 234, information about user groups or roles 236, and information about administrative users within a special administrative group 238. Using this information, authorization server 228 provides indications to proxy server 214 whether a specific request should be allowed to proceed, e.g., whether access to a controlled resource should be granted in response to a request from client 206. It should be noted that the present invention may be implemented in association with a variety of authentication and authorization applications, and the embodiments of the present invention that are depicted herein should not be interpreted as limiting the scope of the present invention with respect to a configuration of authentication and authorization services.

With reference now to FIG. 2B, a block diagram depicts a typical enterprise data processing system that includes a load-balancing server with multiple reverse proxy servers. FIG. 2B is similar to FIG. 2A; common elements have identical reference numerals, although some common elements are not shown in each figure. Whereas FIG. 2A shows a data processing system with some of the server-side entities that may be used to support client requests, including reverse proxy server 214, FIG. 2B shows a similar data processing system with a plurality of redundant reverse proxy servers, hereinbelow also termed proxy server replicas or reverse proxy server replicas. Load-balancing server 250 accepts requests from clients and distributes the requests across a set of proxy server replicas in accordance with an appropriate load-balancing algorithm. Proxy servers 252 and 254 are similar to proxy server 214 such that each proxy server contains similar components; FIG. 2A shows that each proxy server contains a cache for storing session management information, while FIG. 2B shows that each proxy server contains a functional unit for managing sessions.

Proxy server 254 contains session management functional unit 256, which performs server-side operations that are appropriate for managing user sessions with respect to proxy server 254, e.g., as described above with respect to FIG. 2A. The proxy server replicas receive incoming requests from load-balancing server 250; a proxy server replica performs some server-side support operations with respect to the incoming request and associated session information, e.g., as described above with respect to proxy server 214. A proxy server then forwards or sends the incoming request to an appropriate application server; after the request has been processed, the application server returns a response to the proxy server replica, which then sends or forwards the response directly or indirectly to the proper requesting client. Session management functional unit 256 contains session cookie generation functional unit 258 that generates session cookies that contain a session identifier; when appropriate, proxy server 254 returns a session cookie along with a response to browser application 204 at client 206, which stores session cookie 260 along with other cookies in its cookie cache 262. In a well known manner, browser application 204 submits session cookie 260 at subsequent points in time when sending a request to enterprise domain 200; enterprise domain 200 may extract a session identifier within a session cookie to associate the incoming request with previously cached session information in order to provide a processing context for the incoming request.

Given the description of FIGS. 1A-2B as background information, the description of the remaining figures relates to the present invention.

With reference now to FIG. 2C, a block diagram depicts a data processing system that includes a load-balancing server with multiple reverse proxy servers that contain functionality for creating and managing session support cookies in accordance with an embodiment of the present invention. FIG. 2C is similar to FIG. 2B; common elements have identical reference numerals. However, FIG. 2C shows enhanced session management functional unit 270 that contains additional functionality over session management functional unit 256 that is shown in FIG. 2B. Enhanced session management functional unit 270 includes session support cookie generation functionality unit 272 and any other functional components for generating and managing session support cookies. Session support cookies are sent and received to/from a requesting client in a manner similar to any other communication protocol cookie, e.g., in a manner similar to a session cookie. Thus, browser application 204 at client 206 stores and retrieves session support cookie 274 within cookie cache 262 in a manner similar to storing and retrieving session cookie 260.

Each proxy server replica has access to an identical copy of session support encryption key 276, which may be provided to a proxy server replica as part of its configuration information. A session support encryption key is obtainable, retrievable, or otherwise provided to a proxy server replica in a secure manner through a secure administrative procedure or a secure programmatic procedure. Session support encryption key 276 may be a symmetric cryptographic key; alternatively, each proxy server replica may share an asymmetric cryptographic key pair such that session support encryption key 276 represents a public/private key pair.

With reference now to FIG. 2D, a block diagram depicts an exchange of a session cookie and a session support cookie between a client and a reverse proxy server in accordance with an embodiment of the present invention. In the present invention, a session support cookie is logically paired with a session cookie; preferably, a proxy server replica produces a session support cookie whenever it produces a session cookie. Common elements in FIG. 2C and FIG. 2D have identical reference numerals. As illustrated in FIG. 2D, a session support cookie should accompany a session cookie whenever the session cookie is transmitted or received by proxy server replica 254 to/from client 206. Whereas session cookie 260 contains a copy of session identifier 280, a session support cookie contains a copy of a session identifier in a protected, confidential format, such as encrypted session identifier 282.

As described above, a cookie can be set at a client by a server via an HTTP Response message that contains a special “SET-COOKIE” header that has at least one name-value pair, wherein the value of the cookie comprises a session identifier in some manner. In a preferred embodiment of the present invention, a session support cookie can be set at a client by a proxy server by placing a “SET-COOKIE” header in an HTML message. An example of a header for setting a session support cookie is:

SET-COOKIE: SessionSupport=B238F917AC32820D52 wherein “SessionSupport” is the name of the cookie and “B238F917AC32820D52” is a hexadecimal value that is formatted as an ASCII string; additional parameters, such as an expiration time, could be included within the cookie header. The value of the SessionSupport cookie represents an encrypted session identifier, i.e. a session identifier that has been encrypted using the copy of the session support encryption key that is possessed by the proxy server replica that has generated the SessionSupport cookie.

The manner in which a session support cookie and a session support encryption key are employed by a proxy server replica is explained in more detail hereinbelow.

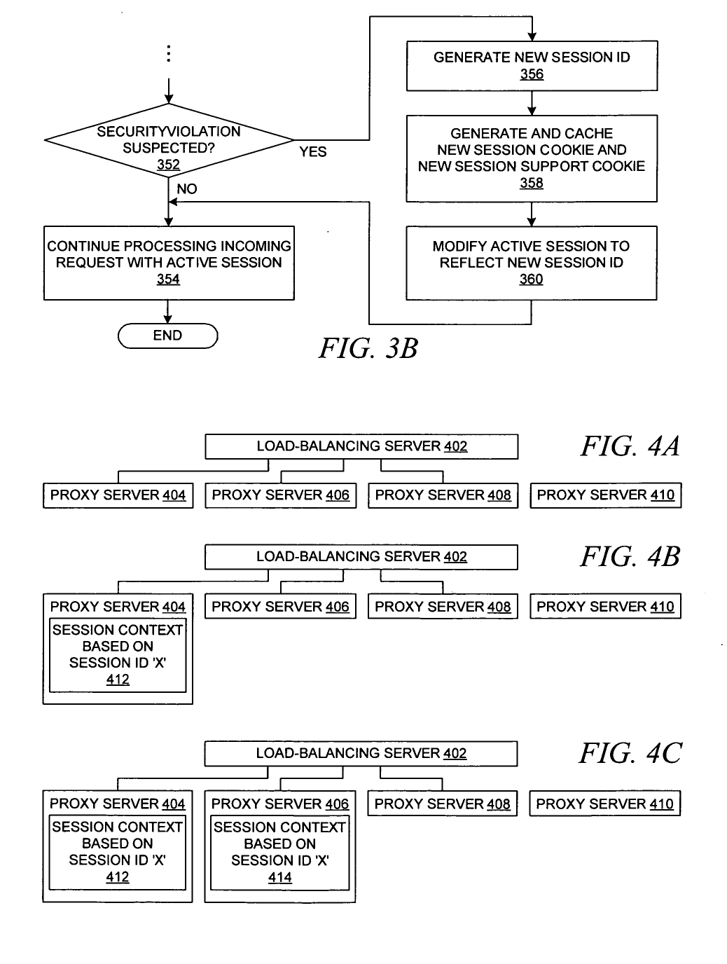

With reference now to FIGS. 3A-3B, a pair of flowcharts depicts a process for determining when a reverse proxy server replica should generate new session identifier for a received resource request in accordance with an embodiment of the present invention. The process that is shown in FIGS. 3A-3B is performed by a reverse proxy server replica when it receives an incoming request to access a resource, e.g., when proxy server replica 254 that is shown in FIG. 2C receives a request message from client 206, such as an HTML request message to access a protected resource.

The process commences with a determination by the reverse proxy server replica as to whether or not the incoming request is accompanied by a session cookie (step 302), e.g., in the form of an HTML cookie as a header on an incoming HTML message. With respect to this illustrated embodiment of the present invention, if the incoming request is not accompanied by a session cookie, then the proxy server cannot retrieve a session identifier that might have been associated with the incoming request and other requests from the requesting client. Since the proxy server does not have the ability to associate the incoming request with an active session for the requesting user/client via a session identifier, then the proxy server cannot process the request within a previously created session context, which would contain authentication credentials and/or other session state information. Hence, the proxy server performs a series of steps to create an active session for the client.

The proxy server initiates an authentication operation for the user (step 304), e.g., by interacting with an authentication server that performs an authentication operation with respect to the user/client. Assuming that the authentication operation is successful, then the proxy server generates a new session identifier (session ID) for the user (step 306). The proxy server generates and caches a session cookie and a session support cookie (step 308), each of which contain the newly generated session identifier in some format as described above; the cookies may be cached within the session context information for ease of retrieval. The proxy server creates an active session for the user (step 310), e.g., by performing additional steps to create whatever session state information may be required. The proxy server then continues to process the incoming request within the context of the active session state information (step 312), and the process is concluded.

It should be noted that a user might be re-authenticated at step 304 if necessary. In other words, the process that is illustrated within FIGS. 3A-3B supports scenarios in which a user might need to be authenticated multiple times within a single user session as viewed from the perspective of the user/client, i.e. across a series of resource requests from the user to one or more application servers; this type of scenario is discussed in more detail hereinbelow.

Returning to step 302, if the incoming request is accompanied by a session cookie, then the proxy server can retrieve a session identifier from the session cookie that might have been associated with the incoming request and other requests from the requesting client. A determination is made as to whether or not the retrieved session identifier from the session cookie is associated with an active session that is currently being maintained by the proxy server (step 314). If so, then the proxy server has the ability to associate the incoming request with an active session for the requesting user/client via the session identifier, and the proxy server can process the request within a previously created session context at step 312, after which the process is concluded.

Returning to step 314, if the incoming request is accompanied by a session cookie but the retrieved session identifier from the session cookie is not associated with an active session that is currently being maintained by the proxy server, then a determination is made as to whether or not the incoming request is accompanied by a session support cookie (step 316). If not, then the proxy server does not have the opportunity to extract a session identifier from a session support cookie. Since the proxy server does not have the ability to associate the incoming request with an active session for the requesting user/client via a session identifier, the proxy server cannot process the request within a previously created session context. Hence, the proxy server performs a series of steps to create an active session for the client via steps 304-310 before processing the request within the newly created session context at step 312, after which the process is concluded.

Returning to step 316, the incoming request has been accompanied by a session cookie, as determined at step 302, but the retrieved session identifier from the session cookie is not associated with an active session that is currently being maintained by the proxy server, as determined at step 314. If the incoming request is accompanied by a session support cookie, as determined at step 316, then the proxy server performs a series of steps to examine the session support cookie.

The proxy server decrypts the session support cookie (step 318), e.g., by decrypting a named value parameter within the session support cookie. The proxy server may extract a session identifier from the decrypted value (step 320), e.g., particularly if the decrypted value contains other information in addition to a session identifier. The proxy server then compares the session identifier that has been extracted from the session support cookie with the session identifier from the session cookie (step 322). A determination is then made as to whether or not the session identifiers match (step 324).

If the session identifiers do not match at step 324, then the proxy server cannot have confidence that either the session identifier within the session cookie or the session identifier within the session support cookie were previously valid. In other words, the proxy server cannot determine whether or not the session identifier within the session cookie or the session identifier within the session support cookie were issued by the proxy server or by some other reverse proxy server replica. At this point, there may be many reasons to assume that some malicious third party may be involved with the incoming request. For example, a session identifier may have been fabricated by a malicious agent, or a malicious agent may be attempting to reuse a stale session identifier, i.e. a so-called replay attack. In any case, the proxy server determines to create a new session for the user. The process branches to step 304 so that the proxy server can perform a series of steps to create an active session for the client based on a newly created session identifier. The incoming request is then processed within the newly created session context at step 312, after which the process is concluded.

If the session identifiers match at step 324, then the proxy server can have confidence that the session identifier is valid for the following reason. A set of reverse proxy server replicas within a given data processing system have been configured in a manner such that they have a trust relationship between themselves; only the reverse proxy server replicas within a given data processing system should have copies of a given session support encryption key. Since the proxy server was able to decrypt and validate the session identifier within the session support cookie, only a reverse proxy server replica could have encrypted the session identifier within the session support cookie. In other words, the proxy server can assume that the session identifier was issued by a reverse proxy server replica within the context of a valid user session at the reverse proxy server replica during a reasonable recent time period. Hence, the proxy server determines to create a new session for the user while reusing the extracted session identifier, i.e. the session identifier from the session cookie or the session support cookie. The process branches to step 310 so that the proxy server can create an active session for the client based on the previously issued session identifier. The incoming request is then processed within the newly created session context at step 312, after which the process is concluded.

Referring now to FIG. 3B, an alternative set of steps is shown that may be used in place of step 312 in FIG. 3A in accordance with an alternative embodiment of the present invention. In a manner similar to that described above with respect to step 324, there may be many reasons to assume that some malicious third party may be involved with the incoming request. For example, a session identifier may be so malformed that the proxy server may suspect that it has been fabricated by a malicious agent, or a malicious agent may be attempting to reuse a stale session identifier, i.e. a so-called replay attack. The flowchart that is shown in FIG. 3B illustrates an alternative embodiment in which such concerns may be addressed with respect to issuing session identifiers.

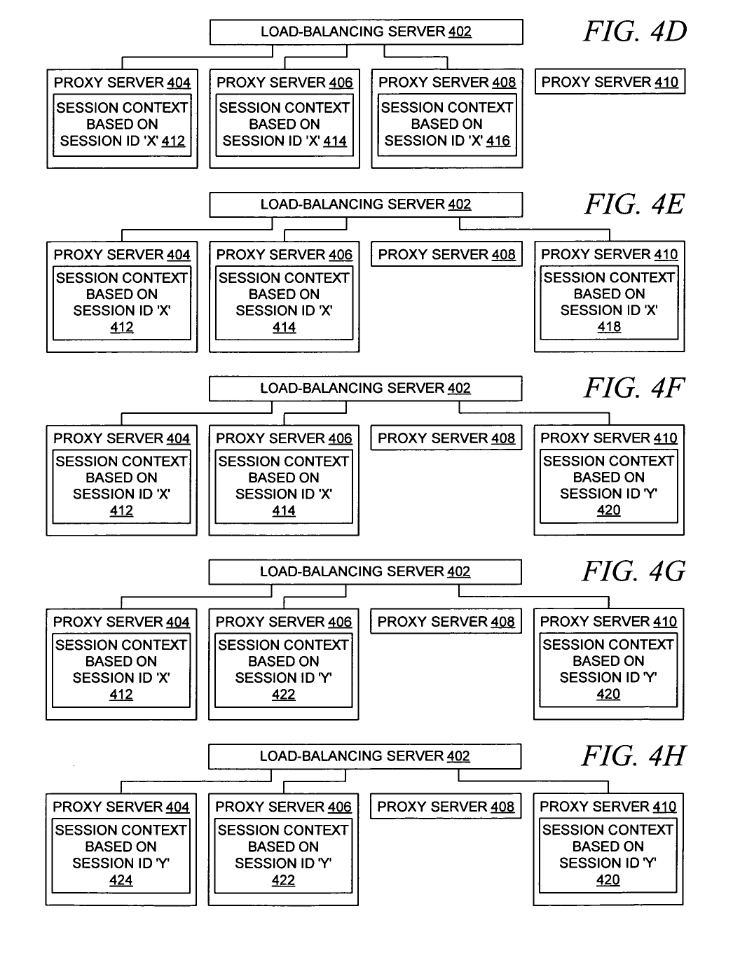

The alternative subprocess that is shown in FIG. 3B commences with a determination of whether or not the proxy server currently suspects or detects that a security violation of some type has occurred (step 352). If not, then the processing of the incoming request continues within the appropriate session context that is associated with the session identifier (step 354), after which the process is concluded. If the proxy server suspects or detects a security violation, then the proxy server generates a new session identifier (step 356). The proxy server also generates and caches a new session cookie and a new session support cookie based on the new session identifier (step 358). The session context information that is associated with the previous session identifier is modified so that it is associated with the new session identifier (step 360). The processing of the request continues at step 354, after which the process is concluded. The consequences of the replacement of a session identifier during an active user session is explained in more detail hereinbelow with respect to FIGS. 4F-4H.

With reference now to FIGS. 4A-4H, a set of block diagrams depict a set of reverse proxy server replicas with respect to partially representative session contexts across a period of time in which requests from a user/client are processed in accordance with an embodiment of the present invention. Common elements in FIGS. 4A-4H have identical reference numerals. FIGS. 4A-4H depict load-balancing server 402 with reverse proxy server replicas 404-410 in a manner similar to that shown in FIG. 2C. In these examples, proxy server replica 410 is initially shown as offline because it has been reserved as a failover backup server. However, it should be noted that the failover scenarios that are discussed hereinbelow do not require an offline backup; if one proxy server in the set of proxy server replicas fails, it may merely be taken offline without activating a special backup proxy server.

As mentioned above, load-balancing server 402 accepts requests from clients and distributes the requests across a set of proxy server replicas in accordance with an appropriate load-balancing algorithm. FIGS. 4A-4H depict snapshots of the states of a set of proxy servers across a series of points in time during which the proxy servers process one or more incoming requests; e.g., FIG. 4A depicts an initial state followed by a subsequent state in FIG. 4B. Although the set of proxy server replicas may handle requests from multiple clients, FIGS. 4A-4H are only concerned with illustrating certain actions with respect to a given client. Proxy server replicas 404-410 may handle other requests from other clients, but FIGS. 4A-4H do not illustrate any changes in their states that may occur in response to those requests. In FIG. 4A, none of the proxy servers has yet created a session context for the given client.

In FIG. 4B, proxy server 404 contains session context 412. Session context 412 represents any data structures, stored data, or any other elements that are employed by proxy server 404 to provide server-side support of a session for a given user/client within a particular period of time. In this example, session context 412 is created because proxy server 404 receives an incoming resource request from load-balancing server 402, and the incoming request is not accompanied by a session cookie. For example, the incoming request might be the first request from a given user/client. Hence, the proxy server generates a new session identifier that is to be associated with the received request and subsequent requests from the same user/client. Session context 412 is associated with and identified by a unique session identifier, shown as session identifier “X” in FIG. 4B. FIG. 4B may represent the state of proxy server 404 after performing steps 302-310 as shown in FIG. 3A.

Referring now to FIG. 4C, at some later point in time, proxy server 406 contains session context 414; session context 414 is associated with and identified by a unique session identifier, shown as session identifier “X”, in a manner similar to FIG. 4B. FIG. 4C illustrates a scenario in which a subsequent incoming request from the given client was received by load-balancing server 402, which then forwarded the request to proxy server 406; in one embodiment of the present invention, the load-balancing server does not ensure that a series of requests from a given client are routed to the same proxy server within a user session. Therefore, in the example that is shown in FIGS. 4B-4C, an initial request from the given client was routed to proxy server 404, and subsequent requests from the same client may have been routed to proxy server 404, but load-balancing server 402 would not have guaranteed those subsequent requests or any additional subsequent requests would be routed to proxy server 404. Hence, at some point in time, load-balancing server 402 has routed at least one request to proxy server 406. When proxy server 406 received the incoming request, the incoming request would have been accompanied by a session cookie and a session support cookie that had been set at the given client by proxy server 404 in response to processing the initial request and any additional subsequent requests that were also processed by proxy server 404. Proxy server 406 has used the session cookie and the session support cookie in the manner that is illustrated in FIG. 3A to accept the session identifier within the cookies, thereby providing continuity, across proxy servers, to the use of the session identifier that originated at proxy server 404 without requiring special handling at load-balancing server 402 with respect to the session identifier.

Referring now to FIG. 4D, at some later point in time, proxy server 408 contains session context 416; session context 414 is associated with and identified by a unique session identifier, shown as session identifier “X”, in a manner similar to FIG. 4B and FIG. 4C. FIG. 4D illustrates a scenario in which a subsequent incoming request from the given client was received by load-balancing server 402, which then forwarded the request to proxy server 408; in other words, the scenario that is illustrated in FIG. 4D is similar to the scenario that is illustrated in FIG. 4C.

In the example that is shown in FIG. 4D, any incoming requests from the given client may be routed by load-balancing server 402 to proxy server 404, proxy server 406, or proxy server 408. Referring back to FIG. 3A, when a proxy server recognizes at steps 302 and 314 that an incoming request is accompanied by a session cookie that contains a valid, recognized, active session identifier, then the proxy server will continue to process the incoming request in accordance with the session context that is associated with the session identifier. Thus, for some period of time, incoming requests from a given client may be routed to multiple proxy servers, each of which possesses session context information for supporting the incoming requests from the given client without triggering additional authorization operations or any other type of operation based on a failure to recognize an associated session identifier. In other words, the associated session identifier on those incoming subsequent requests would be recognized, and the incoming requests would be efficiently processed. At some subsequent point in time, a proxy server may perform a cleanup operation to delete or clear the session context. However, the proxy server replicas may be configured to hold a session context for a threshold time period before performing a cleanup operation to delete or clear the session context information which has been triggered by a timeout violation; if the session cookies or session support cookies contain expiration parameters, then the expiration periods of the cookies would be set accordingly.

Referring now to FIG. 4E, at some later point in time, proxy server 410 contains session context 418; session context 418 is associated with and identified by a unique session identifier, shown as session identifier “X”, in a manner similar to FIGS. 4B-4D. FIG. 4E illustrates a scenario in which a subsequent incoming request from the given client was received by load-balancing server 402, which then forwarded the request to proxy server 410; in other words, the scenario that is illustrated in FIG. 4E is similar to the scenario that is illustrated in FIG. 4C or FIG. 4D.

However, FIG. 4E also illustrates that the present invention may be implemented within a data processing system that supports failover operations among redundant servers. As mentioned above, FIG. 4D represents a snapshot of the state of a set of proxy server replicas at a moment in time, and FIG. 4E represents a snapshot at a subsequent moment in time. During the time period between the illustrated points in time, proxy server 408 has failed and has been taken offline, and proxy server 410 has been brought online. A session context for the given client was created on proxy server 410 using the session support cookie mechanism of the present invention without disrupting the flow of operations with respect to the client. For example, proxy server 410 now has a session context for supporting requests from the given client, yet proxy server 410 did not inject any undesirable operations, such as re-authenticating a user, into the transactions with respect to the given client in order to create its session context. By recognizing a session identifier that was previously employed by other proxy servers, proxy server 410 was able to be integrated into operations with respect to the given client such that the operations of proxy server 410 resemble those of proxy server 404 or proxy server 406 without requiring any centralized coordination between the proxy servers. Moreover, the consequences of the failover event has been handled by the process that is illustrated within FIG. 3A without any consideration or special notification of the existence of the failover event.

Referring now to FIG. 4F, at some later point in time, proxy server 410 contains session context 420; session context 420 is associated with and identified by a unique session identifier, shown as session identifier “Y”. FIG. 4F illustrates a scenario in which a subsequent incoming request from the given client was received by load-balancing server 402, which then forwarded the request to proxy server 410. However, based on a configurable set of rules, proxy server 410 either has detected or has suspected a security violation. Upon its own initiation, e.g., as discussed with respect to FIG. 3B, proxy server 410 has discarded an otherwise valid session identifier, i.e. session identifier “X”, that has been previously employed across multiple proxy servers, as illustrated in FIGS. 4B-4E. As a consequence, proxy server has issued a new session identifier, i.e. session identifier “Y”, which has been associated with the session context information for the given client and which has been included within a session cookie and a session support cookie that has been returned to the given client.

In this manner, any proxy server replica can replace an otherwise valid session identifier with a new session identifier without disrupting the flow of operations with respect to the given client. In other words, proxy server 410 now has a new session identifier for supporting requests from the given client, yet proxy server 410 did not inject any undesirable operations, such as re-authenticating a user, into the transactions with respect to the given client after creating the new session identifier. It should be noted, though, that a user/client may be re-authenticated, if desired, e.g., based on the severity of the detected or suspected security violation; step 304 in FIG. 3A notes that the process that is illustrated within FIG. 3A supports re-authentication operations.

Referring now to FIG. 4G, at some later point in time, proxy server 406 contains session context 422; session context 422 is associated with and identified by a unique session identifier, shown as session identifier “Y”, in a manner similar to FIG. 4F. FIG. 4G illustrates a scenario in which a subsequent incoming request from the given client was received by load-balancing server 402, which then forwarded the request to proxy server 406. When proxy server 406 extracted the new session identifier, i.e. session identifier “Y”, from the session cookie that accompanied the incoming request, proxy server 406 would not have recognized the new session identifier. However, proxy server 406 has used the session cookie and the session support cookie in the manner that is illustrated in FIG. 3A to accept the new session identifier within the cookies, thereby providing continuity between proxy server 410 and 406 to the use of the new session identifier that originated at proxy server 410 without requiring special handling at load-balancing server 402 with respect to the session identifier. Moreover, the new session identifier has been accepted by proxy server 406 without any centralized communication of the new session identifier or without any back-channel or side-channel communication of the new session identifier between the proxy servers.

Referring now to FIG. 4H, at some later point in time, proxy server 404 contains session context 424; session context 424 is associated with and identified by a unique session identifier, shown as session identifier “Y”, in a manner similar to FIG. 4F and FIG. 4G. FIG. 4H illustrates a scenario in which a subsequent incoming request from the given client was received by load-balancing server 402, which then forwarded the request to proxy server 404, which then failed to initially recognize the new session identifier yet accepted the new session identifier. In other words, the scenario that is illustrated in FIG. 4H is similar to the scenario that is illustrated in FIG. 4G. In the example that is shown in FIG. 4H, any incoming requests from the given client may be routed by load-balancing server 402 to proxy server 404, proxy server 406, or proxy server 410; using the accompanying session cookie, the request would be processed by the proxy server replicas using the current session context information.

The advantages of the present invention should be apparent in view of the detailed description of the exemplary embodiments of the present invention as discussed hereinabove. In a typical, prior art, centralized solution, a server maintains session state across multiple server replicas in a centralized datastore or acts as a centralized communication router to ensure that all servers receives updates of session state information. For example, a server contacts a centralized server prior to establishing a new session. In such centralized solutions, fault-tolerance and redundancy can require complex modifications.

In contrast, the present invention provides a decentralized solution. With the present invention, additional centralized servers are not required; the proxy servers themselves determine when a new session should and can be created. With the present invention, a proxy server does not issue a new session identifier unless it decides that it must do so. A proxy server attempts to reuse a session identifier when it can be validated; when presented with a session identifier within a session cookie or session support cookie, a proxy server reuses the session identifier if it can validate the session identifier.

The proxy servers are assumed to maintain session contexts that persists for some period of time. Hence, the solution that is provided by the present invention has the benefit of “round tripping” a session identifier. For example, within a given user session, if a user submits a resource request that is routed to a proxy server that has already processed a request from the user, then the proxy server may still have a valid session context from the previously processed request.

Two significant advantages of the present invention are related to failover operations and load-balancing operations. First, the present invention can be integrated within a data processing environment that supports failovers, including a failover mechanism amongst proxy servers. Second, the present invention can be integrated within a data processing environment that supports nonsticky load-balancing operations.

Furthermore, if a proxy server detects some type of security vulnerability or anomaly, e.g., based on a suspicious request that has supposedly been issued by a previously authenticated user/client, then the proxy server can change the session identifier, which eventually results in the use of the new session identifier by all other proxy server replicas during the same user session, thereby improving performance.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

A method is generally conceived to be a self-consistent sequence of steps leading to a desired result. These steps require physical manipulations of physical quantities. Usually, though not necessarily, these quantities take the form of electrical or magnetic signals capable of being stored, transferred, combined, compared, and otherwise manipulated. It is convenient at times, principally for reasons of common usage, to refer to these signals as bits, values, parameters, items, elements, objects, symbols, characters, terms, numbers, or the like. It should be noted, however, that all of these terms and similar terms are to be associated with the appropriate physical quantities and are merely convenient labels applied to these quantities.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method of managing session identifiers amongst a set of servers within a data processing system, the computer-implemented method comprising:
receiving a first resource request from a client at a first server in the set of servers;
in response to a determination that the first resource request is not accompanied by a cookie that contains a session identifier, generating a first session identifier on the first server and associating by the first server the first session identifier with a newly created first session on the first server, wherein the first session has session state information to be employed by the first server with respect to resource requests from the client; and
sending a response for the first resource request from the first server to the client, wherein the response for the first resource request is accompanied by a first cookie and a second cookie that are generated by the first server, wherein the first cookie contains a copy of the first session identifier and the second cookie contains a copy of the first session identifier that has been cryptographically protected using a cryptographic key, wherein each server in the set of servers possesses a copy of the cryptographic key.

2. The method of claim 1 further comprising:
successfully performing an authentication operation with respect to a user of the client prior to creating the first session on the first server.

3. The method of claim 1 further comprising:
receiving a second resource request from the client at a second server in the set of servers, wherein the second resource request is accompanied by a copy of the first cookie and a copy of the second cookie.

4. The method of claim 3 further comprising:
obtaining the first session identifier from the copy of the first cookie; and
in response to a determination that the second server recognizes the first session identifier from the copy of the first cookie, processing the second resource request with respect to session state information that is associated with the first session identifier as maintained on the second server.

5. The method of claim 3 further comprising:
obtaining the first session identifier from the copy of the first cookie;
in response to a determination that the second server does not recognize the first session identifier from the copy of the first cookie, decrypting at least a portion of the second cookie using the copy of the cryptographic key at the second server;
in response to a determination by the second server that a session identifier from the decrypted portion of the second cookie is identical to the first session identifier, associating by the second server the first session identifier with a newly created second session on the second server, wherein the second session has session state information to be employed by the second server with respect to resource requests from the client.

6. The method of claim 3 further comprising:
obtaining the first session identifier from the copy of the first cookie;
in response to a determination that the second server does not recognize the first session identifier from the copy of the first cookie, decrypting at least a portion of the second cookie using the copy of the cryptographic key at the second server;
in response to a determination by the second server that a session identifier from the decrypted portion of the second cookie is not identical to the first session identifier, generating a second session identifier on the second server and associating by the second server the second session identifier with a newly created second session on the second server, wherein the second session has session state information to be employed by the second server with respect to resource requests from the client.

7. The method of claim 3 further comprising:
receiving the second resource request from the client at a load-balancing server within the data processing system;
evaluating a load-balancing algorithm at the load-balancing server;
determining an appropriate server to receive the second resource request without examination of session identifiers that are accompanying the second resource request; and
forwarding the second resource request from the load-balancing server to the second server prior to receipt of the second resource request at the second server.

8. The method of claim 3 wherein the second server is the first server.

9. The method of claim 3 further comprising:
sending a second response for the second resource request from the second server to the client, wherein the second response is accompanied by a copy of the first cookie and a copy of the second cookie that are generated by the second server.

10. The method of claim 3 further comprising:
receiving a third resource request from the client at a third server in the set of servers, wherein the third resource request is accompanied by a copy of the first cookie and a copy of the second cookie;
in response to a determination by the third server of a detected security violation or a suspected security violation with respect to the third resource request, generating a third session identifier on the third server and replacing the first session identifier with the third session identifier such that the third session identifier is associated by the third server with a third session on the third server, wherein the third session has session state information to be employed by the third server with respect to resource requests from the client; and
sending a response for the third resource request from the third server to the client, wherein the response for the third resource request is accompanied by a third cookie and a fourth cookie that are generated by the third server, wherein the third cookie contains a copy of the third session identifier and the fourth cookie contains a copy of the third session identifier that has been cryptographically protected using the cryptographic key.

11. The method of claim 1 further comprising:
detecting failure of a server in the set of servers; and
supporting a failover operation within the data processing system such that the failed server is removed from online status within the set of server without replacing a session identifier for a session that is maintained by the failed server for the client.

12. An apparatus for managing session identifiers amongst a set of servers within a data processing system, the apparatus comprising:
means for receiving a first resource request from a client at a first server in the set of servers;
means for generating a first session identifier on the first server and associating by the first server the first session identifier with a newly created first session on the first server in response to a determination that the first resource request is not accompanied by a cookie that contains a session identifier, wherein the first session has session state information to be employed by the first server with respect to resource requests from the client;
means for sending a response for the first resource request from the first server to the client, wherein the response for the first resource request is accompanied by a first cookie and a second cookie that are generated by the first server, wherein the first cookie contains a copy of the first session identifier and the second cookie contains a copy of the first session identifier that has been cryptographically protected using a cryptographic key, wherein each server in the set of servers possesses a copy of the cryptographic key.

13. The apparatus of claim 12 further comprising:
means for receiving a second resource request from the client at a second server in the set of servers, wherein the second resource request is accompanied by a copy of the first cookie and a copy of the second cookie;
means for obtaining the first session identifier from the copy of the first cookie; and
means for processing the second resource request with respect to session state information that is associated with the first session identifier as maintained on the second server in response to a determination that the second server recognizes the first session identifier from the copy of the first cookie.

14. The apparatus of claim 12 further comprising:
means for receiving a second resource request from the client at a second server in the set of servers, wherein the second resource request is accompanied by a copy of the first cookie and a copy of the second cookie;
means for obtaining the first session identifier from the copy of the first cookie;
means for decrypting at least a portion of the second cookie using the copy of the cryptographic key at the second server in response to a determination that the second server does not recognize the first session identifier from the copy of the first cookie;
means for associating by the second server the first session identifier with a newly created second session on the second server in response to a determination by the second server that a session identifier from the decrypted portion of the second cookie is identical to the first session identifier, wherein the second session has session state information to be employed by the second server with respect to resource requests from the client.

15. The apparatus of claim 12 further comprising:
means for receiving a second resource request from the client at a second server in the set of servers, wherein the second resource request is accompanied by a copy of the first cookie and a copy of the second cookie;
means for obtaining the first session identifier from the copy of the first cookie;
means for decrypting at least a portion of the second cookie using the copy of the cryptographic key at the second server in response to a determination that the second server does not recognize the first session identifier from the copy of the first cookie;
means for generating a second session identifier on the second server and associating by the second server the second session identifier with a newly created second session on the second server in response to a determination by the second server that a session identifier from the decrypted portion of the second cookie is not identical to the first session identifier, wherein the second session has session state information to be employed by the second server with respect to resource requests from the client.

16. A computer program product on a computer-readable medium for use within a data processing system for managing session identifiers amongst a set of servers, the computer program product comprising:
instructions for receiving a first resource request from a client at a first server in the set of servers;
instructions for generating a first session identifier on the first server and associating by the first server the first session identifier with a newly created first session on the first server in response to a determination that the first resource request is not accompanied by a cookie that contains a session identifier, wherein the first session has session state information to be employed by the first server with respect to resource requests from the client; and
instructions for sending a response for the first resource request from the first server to the client, wherein the response for the first resource request is accompanied by a first cookie and a second cookie that are generated by the first server, wherein the first cookie contains a copy of the first session identifier and the second cookie contains a copy of the first session identifier that has been cryptographically protected using a cryptographic key, wherein each server in the set of servers possesses a copy of the cryptographic key.

17. The computer program product of claim 16 further comprising:
instructions for receiving a second resource request from the client at a second server in the set of servers, wherein the second resource request is accompanied by a copy of the first cookie and a copy of the second cookie;
instructions for obtaining the first session identifier from the copy of the first cookie; and
instructions for processing the second resource request with respect to session state information that is associated with the first session identifier as maintained on the second server in response to a determination that the second server recognizes the first session identifier from the copy of the first cookie.

18. The computer program product of claim 16 further comprising:
instructions for receiving a second resource request from the client at a second server in the set of servers, wherein the second resource request is accompanied by a copy of the first cookie and a copy of the second cookie;
instructions for obtaining the first session identifier from the copy of the first cookie;
instructions for decrypting at least a portion of the second cookie using the copy of the cryptographic key at the second server in response to a determination that the second server does not recognize the first session identifier from the copy of the first cookie;
instructions for associating by the second server the first session identifier with a newly created second session on the second server in response to a determination by the second server that a session identifier from the decrypted portion of the second cookie is identical to the first session identifier, wherein the second session has session state information to be employed by the second server with respect to resource requests from the client.

19. The computer program product of claim 16 further comprising:
instructions for receiving a second resource request from the client at a second server in the set of servers, wherein the second resource request is accompanied by a copy of the first cookie and a copy of the second cookie;
instructions for obtaining the first session identifier from the copy of the first cookie;
instructions for decrypting at least a portion of the second cookie using the copy of the cryptographic key at the second server in response to a determination that the second server does not recognize the first session identifier from the copy of the first cookie;
instructions for generating a second session identifier on the second server and associating by the second server the second session identifier with a newly created second session on the second server in response to a determination by the second server that a session identifier from the decrypted portion of the second cookie is not identical to the first session identifier, wherein the second session has session state information to be employed by the second server with respect to resource requests from the client.
